(19) United States
(12) Patent Application Publication
(10) Pub. No.: US 2021/0083550 A1
(43) Pub. Date: Mar. 18, 2021

(54) ELECTRIC ACTUATOR

(71) Applicant: NIDEC TOSOK CORPORATION, Kanagawa (JP)

(72) Inventor: Shun KATO, Kanagawa (JP)

(73) Assignee: NIDEC TOSOK CORPORATION, Kanagawa (JP)

(21) Appl. No.: 17/013,820

(22) Filed: Sep. 7, 2020

(30) Foreign Application Priority Data
Sep. 13, 2019 (JP) 2019-166973

(51) Int. Cl. H02K 7/116; H02K 5/173; H02K 7/08; H02K 11/21

(52) U.S. Cl. CPC H02K 7/116; H02K 11/21; H02K 7/083; H02K 5/1732

(57) ABSTRACT

An electric actuator includes: a motor part including a motor shaft extending in an axial direction; a deceleration mechanism connected to one axial side of the motor shaft; an output part including an output shaft to which rotation of the motor shaft is transmitted via the deceleration mechanism; and a housing accommodating the motor part, the deceleration mechanism, and the output part. A ratio between a first distance from a meshing position where a first meshing part meshes with a second meshing part to a central axis of the motor shaft, and a second distance from the meshing position to a central axis of the output shaft, when viewed along the axial direction, changes in at least a portion of a range from a first rotation angle to a second rotation angle of the output shaft.

### CROSS-REFERENCE TO RELATED APPLICATIONS

The present invention claims priority under 35 U.S.C. § 119 to Japanese Application No. 2019-166973, filed on Sep. 13, 2019, the entire content of which is incorporated herein by reference.

### FIELD OF THE INVENTION

The disclosure relates to an electric actuator.

### BACKGROUND

An electric actuator is known, which includes a motor part, a deceleration mechanism connected to the motor part, and an output part to which the rotation of the motor part is transmitted via the deceleration mechanism. For example, there is an electric actuator mounted on an automatic transmission that shifts the engine output for vehicle running.

In the electric actuator as described above, the output required to drive a drive target may differ according to the rotation angle of the output part. In this case, it is necessary to determine the maximum output of the electric actuator according to the maximum output of the required outputs. Therefore, for example, even if the output other than the maximum output of the required outputs is small overall, as the required maximum output increases, the size of the electric actuator needs to be increased to increase the maximum output. As a consequence, the electric actuator cannot be sufficiently miniaturized.

### SUMMARY

According to an exemplary embodiment of the disclosure, an electric actuator includes: a motor part including a motor shaft extending in an axial direction; a deceleration mechanism connected to one axial side of the motor shaft; an output part including an output shaft to which rotation of the motor shaft is transmitted via the deceleration mechanism; and a housing accommodating the motor part, the deceleration mechanism, and the output part. The output shaft extends in the axial direction of the motor shaft and is arranged away from the motor shaft when viewed along the axial direction. The deceleration mechanism includes an output gear to which rotation of the motor shaft is decelerated and transmitted. The output part includes a drive gear which is fixed to the output shaft and meshes with the output gear. The output gear includes a first meshing part which meshes with the drive gear. The drive gear extends toward the output gear and includes a second meshing part which meshes with the first meshing part at a tip end. The first meshing part and the second meshing part mesh with each other within a range from a first rotation angle to a second rotation angle of a rotation angle of the output shaft. A ratio between a first distance from a meshing position where the first meshing part meshes with the second meshing part to a central axis of the motor shaft, and a second distance from the meshing position to a central axis of the output shaft, when viewed along the axial direction, changes in at least a portion of the range from the first rotation angle to the second rotation angle.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a diagram showing the actuator device including the electric actuator of the present embodiment, and is a diagram showing a state where the lock gear is set to the locked state by the actuator device.

FIG. 2 is a diagram showing the actuator device including the electric actuator of the present embodiment, and is a diagram showing a state where the lock gear is set to the unlocked state by the actuator device.

FIG. 3 is a cross-sectional diagram showing the electric actuator of the present embodiment.

FIG. 4 is a diagram of a portion of the electric actuator of the present embodiment as viewed from the lower side.

FIG. 5 is a diagram of a portion of the electric actuator of the present embodiment as viewed from the lower side, and is a diagram showing a state where the output shaft has rotated from the state shown in FIG. 4.

FIG. 6 is a diagram of a portion of the electric actuator of the present embodiment as viewed from the lower side, and is a diagram showing a state where the output shaft has further rotated from the state shown in FIG. 5.

### DETAILED DESCRIPTION

In each drawing, the Z-axis direction is a vertical direction with the positive side as the upper side and the negative side as the lower side. The axial direction of the central axis J1 which is a virtual axis appropriately shown in each drawing is parallel to the Z-axis direction, that is, the vertical direction. The X-axis direction is a direction orthogonal to the Z-axis direction. The Y-axis direction is a direction orthogonal to both the Z-axis direction and the X-axis direction. In the following description, the direction parallel to the axial direction of the central axis J1 is simply referred to as “axial direction Z”, the direction parallel to the X-axis direction is referred to as “left-right direction X”, and the direction parallel to the Y-axis direction is referred to as “front-rear direction Y”. In the left-right direction X, the positive side in the X-axis direction (+X side) is referred to as “right side”, and the negative side in the X-axis direction (−X side) is referred to as “left side”. In the front-rear direction Y, the positive side in the Y-axis direction (+Y side) is referred to as “front side”, and the negative side in the Y-axis direction (−Y side) is referred to as “rear side”. Further, unless otherwise specified, the radial direction centered on the central axis J1 is simply referred to as “radial direction”, and the circumferential direction centered on the central axis J1 is simply referred to as “circumferential direction”.

In the present embodiment, the lower side corresponds to one axial side. In the present embodiment, a plan view means to observe from the upper side or the lower side along the axial direction Z. Nevertheless, the vertical direction, the left-right direction, the front-rear direction, the upper side, the lower side, the right side, the left side, the front side, and the rear side are simply names for explaining the relative positional relationship between the parts, and the actual layout relationship may be other than the layout relationship indicated by these names.

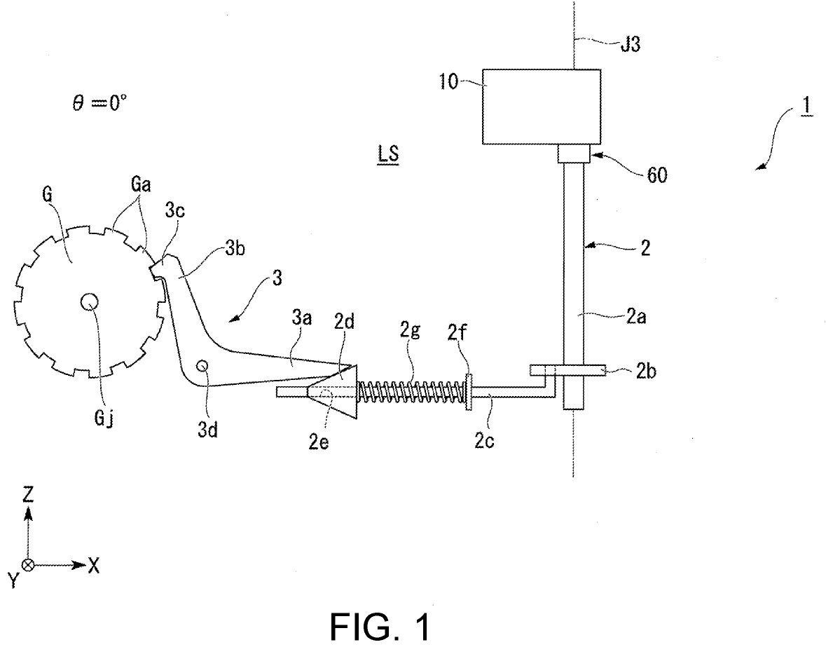

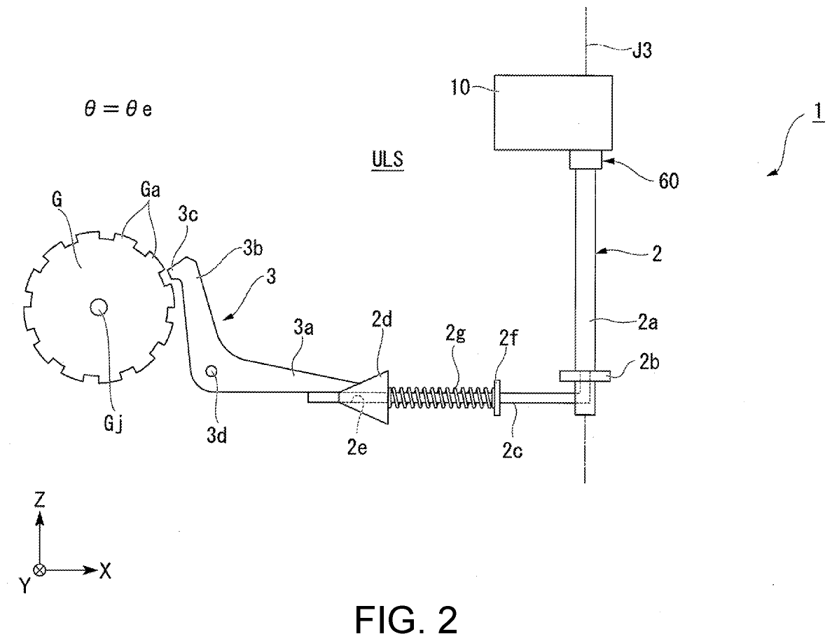

An electric actuator 10 of the present embodiment shown in FIG. 1 and FIG. 2 is attached to a vehicle. More specifically, the electric actuator 10 is mounted on, for example, a park-by-wire type actuator device 1 that is driven based on a shift operation of a driver of the vehicle. The actuator device 1 switches a lock gear G between a locked state LS and an unlocked state ULS based on the shift operation of the driver. The actuator device 1 sets the lock gear G to the locked state LS when the vehicle gear is in parking, and sets the lock gear G to the unlocked state ULS when the vehicle gear is other than parking.

The lock gear G is a gear connected to an axle. As shown in FIG. 1 and FIG. 2, the lock gear G has a plurality of teeth Ga on the outer peripheral surface and rotates around a rotation axis Gj that extends in the front-rear direction Y. FIG. 1 shows a case where the lock gear G is in the locked state LS, and FIG. 2 shows a case where the lock gear G is in the unlocked state ULS.

As shown in FIG. 1 and FIG. 2, the actuator device 1 includes an electric actuator 10, a movable part 2, and a lock arm 3. The actuator device 1 is able to switch the state of the lock gear G by operating the lock arm 3 via the movable part 2 by the electric actuator 10.

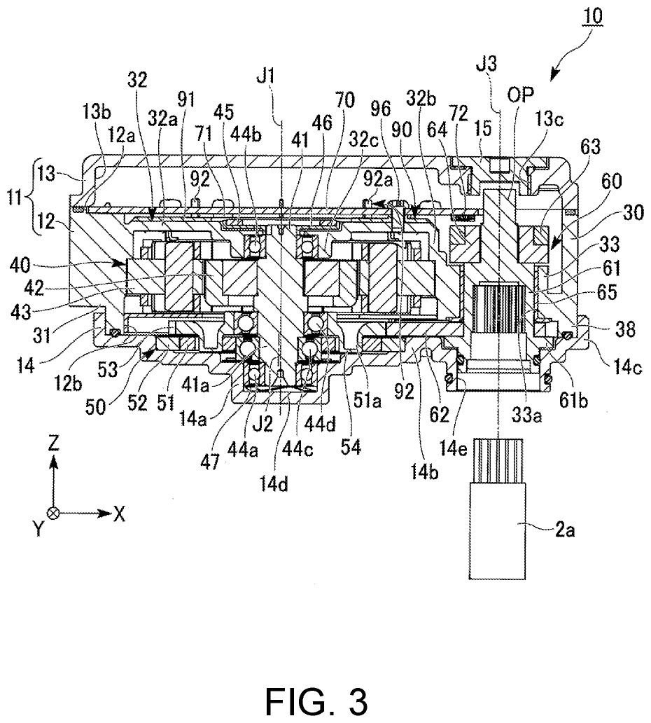

As shown in FIG. 3, the electric actuator 10 includes a motor part 40, a deceleration mechanism 50, an output part 60, a housing 11, a bus bar unit 90, a circuit board 70, a motor part sensor 71, and an output part sensor 72.

The motor part 40 includes a motor shaft 41, a first bearing 44a, a second bearing 44b, a third bearing 44c, a fourth bearing 44d, a rotor body 42, a stator 43, a motor part sensor magnet 45, and a magnet holder 46. The motor shaft 41 extends in the axial direction Z.

The first bearing 44a, the second bearing 44b, the third bearing 44c, and the fourth bearing 44d support the motor shaft 41 rotatably around the central axis J1. In the present embodiment, the first bearing 44a, the second bearing 44b, the third bearing 44c, and the fourth bearing 44d are, for example, ball bearings.

The motor shaft 41 has an eccentric shaft 41a centered on the eccentric axis J2 that is eccentric with respect to the central axis J1. The eccentric shaft 41a is a portion of the motor shaft 41 that is supported by the third bearing 44c. The eccentric axis J2 is parallel to the central axis J1. The eccentric shaft 41a has a columnar or substantially columnar shape extending and centered on the eccentric axis J2. The portion of the motor shaft 41 other than the eccentric shaft 41a has a columnar or substantially columnar shape extending and centered on the central axis J1.

The rotor body 42 is fixed to the motor shaft 41. The rotor body 42 includes a rotor core fixed to the motor shaft 41, and a rotor magnet fixed to the outer peripheral portion of the rotor core.

The stator 43 is arranged on the radial outer side of the rotor body 42 with a gap. The stator 43 has an annular or substantially annular shape surrounding the radial outer side of the rotor body 42. The stator 43 includes, for example, a stator core, a plurality of insulators, and a plurality of coils. Each of the coils is attached to the teeth of the stator core via the insulator.

The magnet holder 46 has an annular or substantially annular shape centered on the central axis J1. The magnet holder 46 is fixed to the outer peripheral surface of the upper end of the motor shaft 41. The motor part sensor magnet 45 has an annular or substantially annular plate shape centered on the central axis J1. The plate surface of the motor part sensor magnet 45 is orthogonal to the axial direction Z. The motor part sensor magnet 45 is fixed to the radial outer peripheral edge of the upper surface of the magnet holder 46. Thus, the motor part sensor magnet 45 is attached to the motor shaft 41 via the magnet holder 46. In the present embodiment, the motor part sensor magnet 45 faces the lower surface of the circuit board 70 in the axial direction Z with a gap.

The deceleration mechanism 50 is connected to the motor part 40. In the present embodiment, the deceleration mechanism 50 is connected to the lower side of the motor shaft 41. The deceleration mechanism 50 is arranged on the lower side of the rotor body 42 and the stator 43. The deceleration mechanism 50 includes an external gear 51, an internal gear 52, an output gear 53, and a plurality of protrusions 54. Nevertheless, the deceleration mechanism 50 may be connected to the upper side of the motor shaft 41. In that case, the upper side corresponds to one axial side.

The external gear 51 has an annular or substantially annular plate shape that expands in the radial direction of the eccentric axis J2 and is centered on the eccentric axis J2 of the eccentric shaft 41a. A gear portion is provided on the radial outer surface of the external gear 51. Although illustration is omitted, the gear portion of the external gear 51 has a plurality of teeth arranged along the outer circumference of the external gear 51. The external gear 51 is connected to the eccentric shaft 41a of the motor shaft 41 via the third bearing 44c. Thus, the deceleration mechanism 50 is connected to the motor shaft 41. The external gear 51 is fitted to the outer ring of the third bearing 44c from the radial outer side. Thus, the third bearing 44c connects the motor shaft 41 and the external gear 51 to be relatively rotatable around the eccentric axis J2.

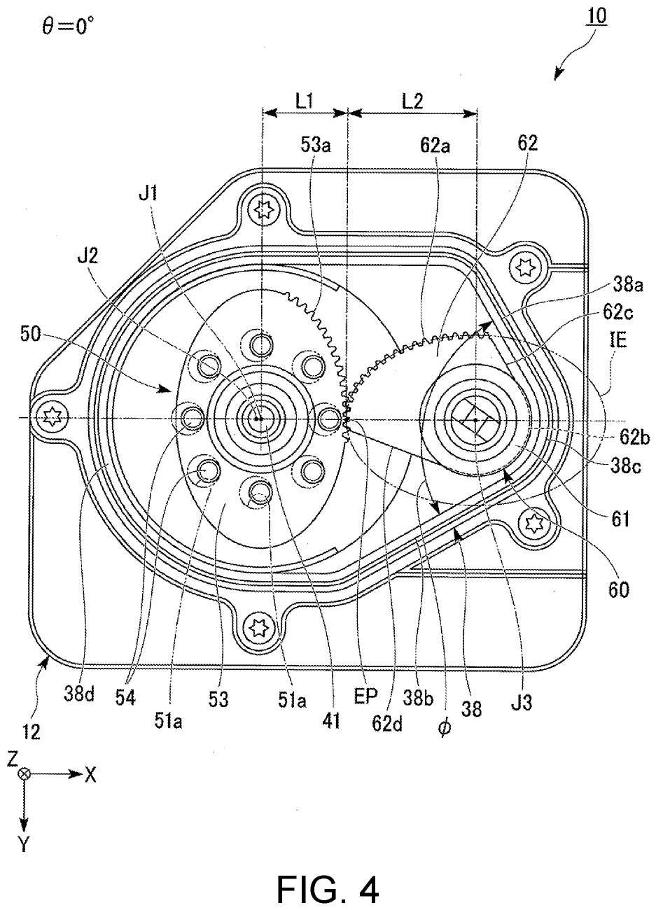

The external gear 51 has a plurality of holes 51a. In the present embodiment, the holes 51a penetrate the external gear 51 in the axial direction Z. As shown in FIG. 4, the plurality of holes 51a are arranged along the circumferential direction. More specifically, the plurality of holes 51a are arranged at equal intervals over the circumference along the circumferential direction centered on the eccentric axis J2. The shape of the hole 51a viewed along the axial direction Z is circular or substantially circular. The hole 51a has an inner diameter larger than the outer diameter of the protrusion 54. The hole 51a may be a hole that has a bottom.

As shown in FIG. 3, the internal gear 52 surrounds the radial outer side of the external gear 51. The internal gear 52 meshes with the external gear 51. More specifically, the gear portion of the internal gear 52 meshes with the gear portion of the external gear 51. The internal gear 52 has an annular or substantially annular shape centered on the central axis J1. The gear portion of the internal gear 52 is provided on the radial inner surface of the internal gear 52 and has a plurality of teeth arranged along the inner circumference of the internal gear 52. The outer peripheral portion of the internal gear 52 has, for example, a polygonal shape such as a regular dodecagon, and is fixed to a second lid member 14 which will be described later while being prevented from rotating.

The output gear 53 is arranged on the upper side of the external gear 51 and the internal gear 52. That is, the external gear 51 is arranged to overlap the output gear 53 when viewed along the axial direction Z. The output gear 53 is connected to the motor shaft 41 via the fourth bearing 44d. As shown in FIG. 4, the output gear 53 has an elliptical or substantially elliptical shape centered on the central axis J1 when viewed along the axial direction Z, for example. In the present embodiment, the output gear 53 is a gear that has a gear portion only on a portion of the outer circumference. In the present embodiment, the gear portion of the output gear 53 is a first meshing part 53a that meshes with a drive gear 62 which will be described later. That is, the output gear 53 has the first meshing part 53a that meshes with the drive gear 62.

The first meshing part 53a has a shape that follows a portion of the outer shape of the output gear 53 when viewed along the axial direction Z, that is, a portion of the ellipse of the motor shaft 41 that is centered on the central axis J1. The first meshing part 53a extends in the circumferential direction along the elliptical shape of the output gear 53. The circumference of the first meshing part 53a is, for example, ¼ or more of the circumference of the output gear 53 having an elliptical or substantially elliptical shape. The first meshing part 53a has a plurality of teeth arranged along the outer circumference of the output gear 53.

As shown in FIG. 3, the plurality of protrusions 54 protrude in the axial direction Z from the output gear 53 toward the external gear 51. The plurality of protrusions 54 each have a cylindrical or substantially cylindrical shape protruding from the lower surface of the output gear 53 toward the lower side. In the present embodiment, the plurality of protrusions 54 are integrally molded with the output gear 53. As shown in FIG. 4, the plurality of protrusions 54 are arranged at equal intervals over the circumference along the circumferential direction. The outer diameter of the protrusion 54 is smaller than the inner diameter of the hole 51a. The plurality of protrusions 54 are respectively inserted into the plurality of holes 51a from the upper side. The outer peripheral surface of the protrusion 54 is inscribed in the inner surface of the hole 51a. The plurality of protrusions 54 support the external gear 51 to be swingable around the central axis J1 via the inner surfaces of the holes 51a.

The output part 60 is a part that outputs the driving force of the electric actuator 10. As shown in FIG. 3, the output part 60 is arranged on the radial outer side of the motor part 40. The output part 60 includes an output shaft 61, the drive gear 62, an output part sensor magnet 63, and a magnet holder 64.

The output shaft 61 has a tubular or substantially tubular shape extending in the axial direction Z of the motor shaft 41. Since the output shaft 61 extends in the same direction as the motor shaft 41, the structure of the deceleration mechanism 50 that transmits the rotation of the motor shaft 41 to the output shaft 61 is able to be simplified. The output shaft 61 is connected to the motor shaft 41 via the deceleration mechanism 50. In the present embodiment, the output shaft 61 has a cylindrical or substantially cylindrical shape centered on an output central axis J3.

The output central axis J3 is parallel to the central axis J1 and is arranged away from the central axis J1 in the radial direction. That is, the output shaft 61 is arranged away from the motor shaft 41 in the radial direction when viewed along the axial direction Z. Therefore, the electric actuator 10 is able to be miniaturized in the axial direction Z as compared with the case where the motor shaft 41 and the output shaft 61 are arranged side by side in the axial direction Z. In the present embodiment, the central axis J1 and the output central axis J3 are arranged side by side with a space in the left-right direction X. The output central axis J3 is located on the right side (+X side) of the central axis J1, for example.

The output shaft 61 opens on the lower side. The output shaft 61 has a spline groove on the inner peripheral surface. The output shaft 61 is arranged at a position overlapping the rotor body 42 in the radial direction of the motor shaft 41. A driven shaft 2a which will be described later is inserted and connected to the output shaft 61 from the lower side. More specifically, as the spline portion provided on the outer peripheral surface of the driven shaft 2a is fitted into the spline groove provided on the inner peripheral surface of the output shaft 61, the output shaft 61 and the driven shaft 2a are connected. The driving force of the electric actuator 10 is transmitted to the driven shaft 2a via the output shaft 61. Thus, the electric actuator 10 rotates the driven shaft 2a around the output central axis J3.

The drive gear 62 is fixed to the output shaft 61 and meshes with the output gear 53. In the present embodiment, the drive gear 62 is fixed to the outer peripheral surface of the output shaft 61. As shown in FIG. 4, the drive gear 62 extends from the output shaft 61 toward the output gear 53. The drive gear 62 has a second meshing part 62a that meshes with the first meshing part 53a at the tip end. The second meshing part 62a is a gear portion having a plurality of teeth arranged along the outer circumference on the drive gear 62. In the present embodiment, the second meshing part 62a has a shape that follows a portion of an ellipse IE centered on the output central axis J3 which is the central axis of the output shaft 61.

The ellipse IE is an imaginary ellipse. The ellipse IE is an ellipse having the same shape and size as the elliptical output gear 53. As shown in FIG. 4, when the short axis of the output gear 53 is arranged along the left-right direction X in which the central axis J1 and the output central axis J3 are arranged side by side, the long axis of the ellipse IE is arranged along the left-right direction X. The second meshing part 62a extends in the circumferential direction along the ellipse IE. The circumference of the second meshing part 62a is, for example, ¼ or more of the circumference of the ellipse IE.

A portion of the outer edge of the drive gear 62 that sandwiches the output central axis J3 with the second meshing part 62a is an arcuate arc portion 62b centered on the output central axis J3. The outer edge of the drive gear 62 further has a pair of straight portions 62c and 62d that respectively connect two ends of the arc portion 62b and two ends of the second meshing part 62a in the circumferential direction centered on the output central axis J3. The straight portion 62c connects one of the two ends of the arc portion 62b that is located on the rear side (−Y side) and one of the two ends of the second meshing part 62a that is located on the rear side. The straight portion 62d connects one of the two ends of the arc portion 62b that is located on the front side (+Y side) and one of the two ends of the second meshing part 62a that is located on the front side. The straight portion 62c and the straight portion 62d extend in a straight line while being inclined away from each other from the arc portion 62b toward the second meshing part 62a.

As shown in FIG. 3, the magnet holder 64 is a substantially cylindrical member extending in the axial direction Z and centered on the output central axis J3. The magnet holder 64 opens on both sides in the axial direction. The magnet holder 64 is fixed to the upper portion of the output shaft 61. In the case of the present embodiment, the magnet holder 64 is arranged on the radial outer side of the second bearing 44b of the motor part 40. The magnet holder 64 partially overlaps the circuit board 70 when viewed in the axial direction Z. The magnet holder 64 is arranged on the lower side with respect to the circuit board 70. The output shaft 61 penetrates the magnet holder 64 in the axial direction Z. The output shaft 61 is press-fitted to the inner side of the magnet holder 64.

The output part sensor magnet 63 has an annular or substantially annular shape centered on the output central axis J3. The output part sensor magnet 63 is fixed to the outer peripheral portion of the upper surface of the magnet holder 64. As the magnet holder 64 is fixed to the output shaft 61, the output part sensor magnet 63 is fixed to the output shaft 61 via the magnet holder 64. The output part sensor magnet 63 faces the lower surface of the circuit board 70 with a gap.

The upper end of the output shaft 61 protrudes on the upper side of the magnet holder 64. The upper end of the output shaft 61 passes through the side end surface of the circuit board 70 and protrudes on the upper side with respect to the circuit board 70. An operation part OP for fitting a tool is provided at the upper end of the output shaft 61. The operation part OP is, for example, a quadrangular prism or a hexagonal prism extending along the output central axis J3.

When the motor shaft 41 is rotated around the central axis J1, the eccentric shaft 41a revolves in the circumferential direction around the central axis J1. The revolution of the eccentric shaft 41a is transmitted to the external gear 51 via the third bearing 44c, and the external gear 51 swings while the position where the inner peripheral surface of the hole 51a and the outer peripheral surface of the protrusion 54 inscribe changes. Thus, the position where the gear portion of the external gear 51 and the gear portion of the internal gear 52 mesh with each other changes in the circumferential direction. Therefore, the rotational force of the motor shaft 41 is transmitted to the internal gear 52 via the external gear 51.

Here, in the present embodiment, the internal gear 52 does not rotate because the internal gear 52 is fixed. Therefore, the external gear 51 rotates around the eccentric axis J2 due to the reaction force of the rotational force transmitted to the internal gear 52. At this time, the direction of rotation of the external gear 51 is opposite to the direction of rotation of the motor shaft 41. The rotation of the external gear 51 around the eccentric axis J2 is transmitted to the output gear 53 via the holes 51a and the protrusions 54. Thus, the output gear 53 rotates around the central axis J1. The rotation of the motor shaft 41 is decelerated and transmitted to the output gear 53.

When the output gear 53 rotates, the drive gear 62 that meshes with the output gear 53 rotates around the output central axis J3. Thus, the output shaft 61 fixed to the drive gear 62 rotates around the output central axis J3. In this way, the rotation of the motor shaft 41 is transmitted to the output shaft 61 via the deceleration mechanism 50.

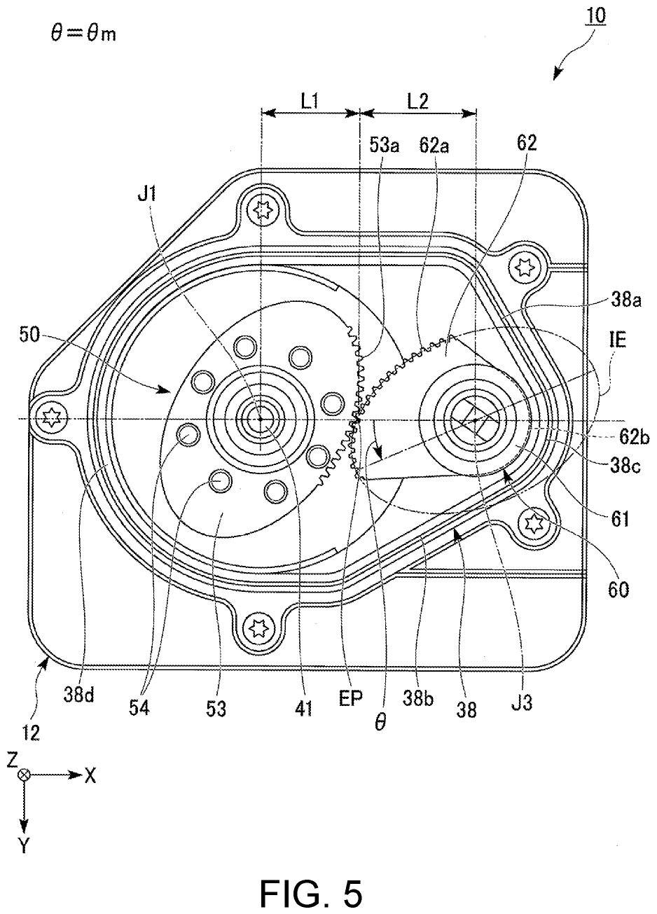

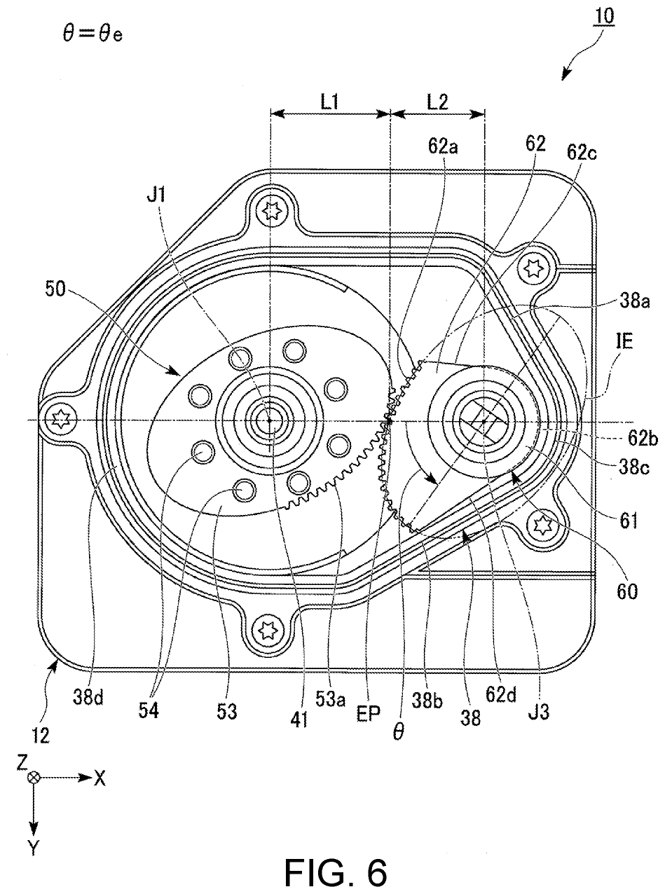

In the electric actuator 10, the output shaft 61 is bidirectionally rotated within a range of not making one revolution. The output shaft 61 of the present embodiment is rotated between the state shown in FIG. 4 and the state shown in FIG. 6. In the following description, the state shown in FIG. 4 is a state where the rotation angle θ of the output shaft 61 is 0°, the state shown in FIG. 5 is a state where the rotation angle θ of the output shaft 61 is an angle θm larger than 0°, and the state shown in FIG. 6 is a state where the rotation angle θ is an angle θe larger than the angle θm. In the present embodiment, when the rotation angle θ is 0°, the lock gear G is in the locked state LS as shown in FIG. 1, and when the rotation angle θ is the angle θe, the lock gear G is in the unlocked state ULS as shown in FIG. 2.

The state shown in FIG. 5 is a state where the output gear 53 rotates clockwise around the central axis J1 as viewed from the lower side, and the drive gear 62 and the output shaft 61 are rotated counterclockwise around the output central axis J3 by the angle θm as viewed from the lower side from the state shown in FIG. 4. The state shown in FIG. 5 is a state between the state shown in FIG. 4 and the state shown in FIG. 6. The angle θm is, for example, about 15° or more and 30° or less.

The state shown in FIG. 6 is a state where the output gear 53 further rotates clockwise around the central axis J1 as viewed from the lower side, and the drive gear 62 and the output shaft 61 are further rotated counterclockwise around the output central axis J3 as viewed from the lower side from the state shown in FIG. 5. In FIG. 6, the drive gear 62 and the output shaft 61 are in a state of being rotated counterclockwise around the output central axis J3 by the angle θe as viewed from the lower side with respect to the state shown in FIG. 4. The angle θe is, for example, about 45° or more and 60° or less.

As described above, in the present embodiment, the output gear 53 and the drive gear 62 mesh with each other within the range where the rotation angle θ of the output shaft 61 is from 0° to the angle θe. That is, the first meshing part 53a and the second meshing part 62a mesh with each other within the range where the rotation angle θ of the output shaft 61 is from 0° to the angle θe. In the present embodiment, 0° corresponds to the first rotation angle and the angle θe corresponds to the second rotation angle.

A meshing position EP where the first meshing part 53a and the second meshing part 62a mesh with each other is arranged in a straight line connecting the central axis J1 and the output central axis J3 when viewed along the axial direction Z. As shown in FIG. 4 to FIG. 6, a ratio between a first distance L1, which is from the meshing position EP to the central axis J1 of the motor shaft 41, and a second distance L2, which is from the meshing position EP to the output central axis J3 of the output shaft 61, when viewed along the axial direction Z, changes in at least a portion of the range from 0°, which is the first rotation angle, to the angle θe, which is the second rotation angle.

In the present embodiment, the ratio between the first distance L1 and the second distance L2 continuously changes from 0°, which is the first rotation angle, toward the angle θe, which is the second rotation angle. More specifically, the ratio of the second distance L2 to the first distance L1 decreases from 0°, which is the first rotation angle, toward the angle θe, which is the second rotation angle. The ratio of the second distance L2 to the first distance L1 is represented by L2/L1.

As the ratio of the second distance L2 to the first distance L1 increases, the deceleration ratio which is the ratio of the rotation speed of the output gear 53 to the rotation speed of the drive gear 62 increases, and the rotational torque output from the output shaft 61 via the drive gear 62 increases. On the other hand, as the ratio of the second distance L2 to the first distance L1 decreases, the deceleration ratio which is the ratio of the rotation speed of the output gear 53 to the rotation speed of the drive gear 62 decreases, and the rotational torque output from the output shaft 61 via the drive gear 62 decreases. When the second distance L2 is smaller than the first distance L1, the deceleration ratio is smaller than 1, and the rotation speed of the drive gear 62 is larger than the rotation speed of the output gear 53.

In the present embodiment, when the rotation angle θ is 0°, the ratio of the second distance L2 to the first distance L1 is the largest. Therefore, when the rotation angle θ is 0°, the rotational torque output from the output shaft 61 is the largest and the output of the electric actuator 10 is the largest. On the other hand, in the present embodiment, when the rotation angle θ is the angle θe, the ratio of the second distance L2 to the first distance L1 is the smallest. Therefore, when the rotation angle θ is the angle θe, the rotational torque output from the output shaft 61 is the smallest and the output of the electric actuator 10 is the smallest. In the present embodiment, the output of the electric actuator 10 decreases as the rotation angle θ changes from 0° to the angle θe.

The sum of the first distance L1 and the second distance L2 is the axial distance between the central axis J1 and the output central axis J3, and is constant regardless of the rotation angle θ. As shown in FIG. 4, when the rotation angle θ is 0°, the second distance L2 is larger than the first distance L1. As shown in FIG. 5, when the rotation angle θ is the angle θm, the second distance L2 is larger than the first distance L1, but smaller than the second distance L2 when the rotation angle θ shown in FIG. 4 is 0°. As shown in FIG. 6, when the rotation angle θ is the angle θe, the second distance L2 is smaller than the first distance L1. In the present embodiment, the first distance L1 continuously increases as the rotation angle θ changes from 0° toward the angle θe. In the present embodiment, the second distance L2 continuously decreases as the rotation angle θ changes from 0° toward the angle θe.

As shown in FIG. 3, the housing 11 accommodates the motor part 40, the deceleration mechanism 50, the output part 60, the circuit board 70, and the bus bar unit 90. The housing 11 includes a housing body 12 having a polygonal shape in the plan view and opening on the upper side, a first lid member 13 fixed to an opening 12a on the upper side of the housing body 12, and a second lid member 14 fixed to an opening 12b on the lower side of the housing body 12.

The housing body 12 includes an outer wall 30 having a polygonal cylindrical shape that defines the case of the electric actuator 10, a bottom wall 31 that expands from the lower end of the outer wall 30 to the radial inner side, and a motor case part 32 and an output shaft holder 33 provided on the bottom wall 31. That is, the housing 11 has the outer wall 30, the bottom wall 31, the motor case part 32, and the output shaft holder 33.

In the present embodiment, the outer wall 30 has a pentagonal cylindrical shape when viewed in the axial direction Z. The outer wall 30 surrounds the motor case part 32 from the radial outer side. The opening on the upper side of the outer wall 30 is the opening 12a on the upper side of the housing body 12. The bottom wall 31 has an opening that opens on the lower side. A tubular wall 38 having a tubular or substantially tubular shape protruding from the bottom wall 31 toward the lower side is provided on the peripheral edge of the opening of the bottom wall 31. The opening surrounded by the tubular wall 38 is the opening 12b on the lower side of the housing body 12.

As shown in FIG. 4, the tubular wall 38 surrounds the output gear 53 and the drive gear 62. The tubular wall 38 includes a first wall 38a, a second wall 38b, a first connection wall 38c, and a second connection wall 38d. That is, the housing 11 includes the first wall 38a, the second wall 38b, the first connection wall 38c, and the second connection wall 38d.

The first wall 38a is a portion located on one side of the drive gear 62 in the circumferential direction centered on the output central axis J3. The second wall 38b is a portion located on the other side of the drive gear 62 in the circumferential direction centered on the output central axis J3. The first wall 38a and the second wall 38b are arranged to sandwich the output shaft 61 in the front-rear direction Y. The first wall 38a is located on the rear side (−Y side) of the output shaft 61. The second wall 38b is located on the front side (+Y side) of the output shaft 61.

The first wall 38a extends in a straight line to be located on the rear side (−Y side) as it goes toward the left side (−X side). The second wall 38b extends in a straight line to be located on the front side (+Y side) as it goes toward the left side. The first wall 38a and the second wall 38b are separated from each other in the front-rear direction Y as they go toward the left side. When viewed along the axial direction Z, the angle φ defined by the first wall 38a and the second wall 38b is 90° or less. In the present embodiment, the angle φ is an acute angle slightly less than 90°.

As shown in FIG. 4, when the rotation angle θ is 0°, the second meshing part 62a comes closest to the first wall 38a, and the first wall 38a faces the straight portion 62c with a slight gap. As shown in FIG. 6, when the rotation angle θ is the angle θe, the second meshing part 62a comes closest to the second wall 38b, and the second wall 38b faces the straight portion 62d with a slight gap.

The first connection wall 38c is a portion that connects the end on the right side (+X side) of the first wall 38a and the end on the right side of the second wall 38b. The first connection wall 38c is located on the right side of the output shaft 61. The first connection wall 38c extends in an arc or substantially arc shape centered on the output central axis J3. The first connection wall 38c faces the arc portion 62b of the drive gear 62 with a gap. The second connection wall 38d is a portion that connects the end on the left side (−X side) of the first wall 38a and the end on the left side of the second wall 38b. The second connection wall 38d is located on the left side of the output gear 53 and on both sides in the front-rear direction Y.

As shown in FIG. 3, the motor case part 32 and the output shaft holder 33 are provided on the upper surface of the bottom wall 31. The motor case part 32 has a tubular or substantially tubular shape surrounding the motor part 40 from the radial outer side. In the present embodiment, the motor case part 32 has a cylindrical or substantially cylindrical shape opening on the lower side and centered on the central axis J1. The motor case part 32 holds the motor part 40 on the inner side. More specifically, the stator 43 of the motor part 40 is fixed to the inner peripheral surface of the motor case part 32. The motor case part 32 has a tubular portion 32b that extends from the bottom wall 31 toward the upper side, and a partition wall 32a having an annular or substantially annular plate shape that expands from the upper end of the tubular portion 32b toward the radial inner side.

The partition wall 32a has a bearing holder 32c at the center when viewed in the axial direction Z. The bearing holder 32c has a cylindrical or substantially cylindrical shape that extends along the axial direction Z. The second bearing 44b is held on the inner peripheral surface of the bearing holder 32c. As the partition wall 32a also serves as the bearing holder, the size of the electric actuator 10 in the axial direction Z is prevented from increasing.

The output shaft holder 33 has a cylindrical or substantially cylindrical shape that extends from the bottom wall 31 toward the upper side. A portion of the side surface of the output shaft holder 33 is connected to the side surface of the motor case part 32. The output shaft holder 33 has a hole 33a that penetrates the output shaft holder 33 in the axial direction Z. A bush 65 having a cylindrical or substantially cylindrical shape is fitted to the inner side of the hole 33a.

The bush 65 has a flange part that protrudes toward the outer side in the radial direction centered on the output central axis J3 at the lower end. The flange part of the bush 65 is supported from the lower side by the upper surface of the drive gear 62. The output shaft 61 is fitted to the inner side of the bush 65. The bush 65 supports the output shaft 61 rotatably around the output central axis J3.

The first lid member 13 is a container-shaped metal member having an accommodating recess 13b that opens on the lower side. The first lid member 13 and the housing body 12 are fastened together by a plurality of bolts penetrating the first lid member 13 in the axial direction Z. The accommodating recess 13b accommodates the electronic component mounted on the upper surface of the circuit board 70 and the operation part OP. The accommodating recess 13b accommodates, for example, a capacitor, a transistor, etc. mounted on the circuit board 70.

The first lid member 13 has an opening 13c located on the upper side of the output shaft 61. A removable cap 15 is attached to the opening 13c. The cap 15 is attached to the opening 13c by, for example, fastening a male screw provided on the outer peripheral surface to a female screw provided on the inner peripheral surface of the opening 13c. By removing the cap 15, a tool is able to be connected to the operation part OP from the outside of the electric actuator 10 via the opening 13c.

The second lid member 14 covers the deceleration mechanism 50 from the lower side. The second lid member 14 is defined by metal in the present embodiment. The second lid member 14 includes an inner tubular portion 14a having a cylindrical or substantially cylindrical shape that is centered on the central axis J1, an outer tubular portion 14b having a polygonal cylindrical shape that is centered on the central axis J1, a fixed tubular portion 14c fixed to the housing body 12, a bottom wall 14d located at the lower end of the inner tubular portion 14a, and an opening 14e overlapping the output part 60 in the axial direction Z.

The inner tubular portion 14a has a smaller inner diameter than the outer tubular portion 14b, and is located on the lower side with respect to the outer tubular portion 14b. The first bearing 44a is held on the radial inner side of the inner tubular portion 14a. A preload member 47 is arranged between the first bearing 44a and the bottom wall 14d in the axial direction Z. That is, the electric actuator 10 includes the preload member 47. The preload member 47 is a wave washer having an annular or substantially annular shape that extends along the circumferential direction. The preload member 47 contacts the upper surface of the bottom wall 14d and the lower end of the outer ring of the first bearing 44a. The preload member 47 applies an upward preload to the outer ring of the first bearing 44a.

The internal gear 52 is held on the radial inner side of the outer tubular portion 14b. The fixed tubular portion 14c is fixed to the outer peripheral surface of the tubular wall 38 of the housing body 12. Thus, the second lid member 14 is fixed to the housing body 12. The second lid member 14 supports the shaft flange part 61b that expands from the outer peripheral surface of the output shaft 61 toward the radial outer side from the lower side. The lower end of the output shaft 61 is exposed to the lower side through the opening 14e of the second lid member 14.

The bus bar unit 90 is arranged on the upper surface of the partition wall 32a. The bus bar unit 90 includes a bus bar holder 91 having an annular or substantially annular plate shape, and a plurality of bus bars 92 held by the bus bar holder 91. Six bus bars 92 are provided, for example. In the case of the present embodiment, the bus bar holder 91 is defined by insert molding using the bus bars 92 as insert members.

The end 92a on one side of the bus bar 92 protrudes from the upper surface of the bus bar holder 91 toward the upper side. In the present embodiment, the end 92a on one side of the bus bar 92 has a straight strip shape that extends in the axial direction Z and penetrates the circuit board 70 from the lower side to the upper side. The end 92a is electrically connected to the circuit board 70 at a position penetrating the circuit board 70 by a connection method such as soldering, welding, or press fitting. Although illustration is omitted, the end on the other side of the bus bar 92 holds a coil lead wire drawn from the coil of the stator 43, and is connected to the coil by soldering or welding. Thus, the stator 43 and the circuit board 70 are electrically connected via the bus bar 92.

In the present embodiment, the circuit board 70 is arranged on the upper side of the motor part 40 and the bus bar unit 90. The circuit board 70 has a plate shape with the plate surface orthogonal to the axial direction Z. Although illustration is omitted, the shape of the circuit board 70 when viewed along the axial direction Z is substantially square. The circuit board 70 is electrically connected to the coils of the stator 43 via the bus bar unit 90. That is, the circuit board 70 is electrically connected to the motor part 40. In the present embodiment, the circuit board 70 is accommodated inside the opening 12a in the housing body 12. The circuit board 70 is covered by the first lid member 13 from the upper side.

In the present embodiment, the circuit board 70 is fastened to the partition wall 32a of the motor case part 32 by a plurality of bolts 96. The bolts 96 penetrate the circuit board 70 and the bus bar holder 91 in the axial direction Z and are fastened to the screw holes of the partition wall 32a. According to this configuration, the circuit board 70 and the bus bar holder 91 are fastened together by the common bolts 96 and are integrated. Thus, fluctuation in the space between the circuit board 70 and the bus bar holder 91 in the axial direction Z due to vibration during operation is able to be suppressed. As a result, the load applied to the connection portion between the bus bars 92 and the circuit board 70 is able to be suppressed. For example, three bolts 96 are provided.

Further, in the present embodiment, the space between the bus bar holder 91 and the circuit board 70 in the axial direction Z is able to be narrowed as compared with the case where the bus bar holder 91 and the circuit board 70 are fixed to the partition wall 32a using separate bolts. Therefore, the size of the electric actuator 10 is prevented from increasing due to the provision of the bus bar holder 91.

The motor part sensor 71 is fixed to the lower surface of the circuit board 70. More specifically, the motor part sensor 71 is fixed to a portion of the lower surface of the circuit board 70 that faces the motor part sensor magnet 45 with a gap in the axial direction Z. The motor part sensor 71 is a magnetic sensor that detects the magnetic field of the motor part sensor magnet 45. The motor part sensor 71 is, for example, a Hall element such as a Hall IC. In the present embodiment, three motor part sensors 71 are provided along the circumferential direction. The motor part sensor 71 detects the magnetic field of the motor part sensor magnet 45, thereby detecting the rotational position of the motor part sensor magnet 45 and detecting the rotation of the motor shaft 41.

The output part sensor 72 is fixed to the lower surface of the circuit board 70. More specifically, the output part sensor 72 is fixed to a portion of the lower surface of the circuit board 70 that faces the output part sensor magnet 63 with a gap in the axial direction Z. The output part sensor 72 is a magnetic sensor that detects the magnetic field of the output part sensor magnet 63. The output part sensor 72 is, for example, a Hall element such as a Hall IC. The output part sensor 72 detects the magnetic field of the output part sensor magnet 63, thereby detecting the rotational position of the output part sensor magnet 63 and detecting the rotation of the output shaft 61.

As shown in FIG. 1, the movable part 2 includes the driven shaft 2a, a connection portion 2b, a rod 2c, a support portion 2d, a flange part 2f, and a coil spring 2g. The driven shaft 2a has a columnar or substantially columnar shape that extends in the axial direction Z. The driven shaft 2a is arranged along the output central axis J3. The driven shaft 2a is rotated around the output central axis J3 by the electric actuator 10. That is, the driven shaft 2a is connected to the output shaft 61. Thus, the movable part 2 is connected to the output shaft 61.

The connection portion 2b is fixed to the driven shaft 2a. The connection portion 2b has a rectangular or substantially rectangular plate shape that extends in one direction. Although illustration is omitted, the connection portion 2b has a fixing hole that penetrates the connection portion 2b in the axial direction Z at one end. The driven shaft 2a passes through the fixing hole and is fixed. Thus, one end of the connection portion 2b is fixed to the driven shaft 2a. The connection portion 2b extends from the driven shaft 2a toward the radial outer side of the output central axis J3.

The rod 2c is arranged movably along the left-right direction X. The end on the right side (+X side) of the rod 2c is connected to the connection portion 2b. The support portion 2d has a truncated cone shape that is centered on an axis extending in the left-right direction X. The outer diameter of the support portion 2d increases from the left side (−X side) toward the right side. The support portion 2d has a through hole 2e that penetrates the support portion 2d in the left-right direction X. The end on the left side of the rod 2c passes through the through hole 2e. The support portion 2d is movable in the left-right direction X with respect to the rod 2c. The support portion 2d and the rod 2c are arranged concentrically, for example.

The flange part 2f is fixed to the rod 2c on the right side (+X side) with respect to the support portion 2d. The coil spring 2g extends in the left-right direction X. The coil spring 2g is arranged between the support portion 2d and the flange part 2f in the left-right direction X. The rod 2c passes through the inner side of the coil spring 2g. The end on the right side of the coil spring 2g is fixed to the flange part 2f. The end on the left side (−X side) of the coil spring 2g is fixed to the support portion 2d. The coil spring 2g expands and contracts as the support portion 2d relatively moves in the left-right direction X with respect to the rod 2c, and applies an elastic force in the left-right direction X to the support portion 2d.

The movable part 2 is driven by the electric actuator 10. Specifically, the driven shaft 2a is rotated around the output central axis J3 by the electric actuator 10. With the rotation of the driven shaft 2a, the connection portion 2b also rotates around the output central axis J3. The rod 2c moves in the left-right direction X as the connection portion 2b rotates around the output central axis J3. The rod 2c moves to the right side (+X side) as the connection portion 2b rotates counterclockwise when viewed from the lower side. The rod 2c moves to the left side (−X side) as the connection portion 2b rotates clockwise when viewed from the lower side. With the movement of the rod 2c in the left-right direction X, the support portion 2d, the flange part 2f, and the coil spring 2g also move in the left-right direction X. The movable part 2 is driven within a range in which the output shaft 61 of the electric actuator 10 rotates.

The lock arm 3 is arranged on the left side (−X side) of the movable part 2. The lock arm 3 is arranged rotatably around a rotation shaft 3d. The rotating shaft 3d is a shaft extending in the front-rear direction Y. The lock arm 3 has a first portion 3a and a second portion 3b. The first portion 3a extends from the rotation shaft 3d toward the right side (+X side). The end on the right side of the first portion 3a contacts the outer peripheral surface of the support portion 2d. The second portion 3b extends from the rotation shaft 3d toward the upper side with a slight inclination to the left side. The second portion 3b has a meshing part 3c that protrudes toward the left side at the upper end.

The lock arm 3 moves as the movable part 2 moves. More specifically, the lock arm 3 rotates around the rotation shaft 3d as the rod 2c and the support portion 2d move in the left-right direction X. When the driven shaft 2a and the connection portion 2b rotate clockwise, when viewed from the lower side, from the state shown in FIG. 2, the rod 2c and the support portion 2d move toward the left side (−X side). Since the outer diameter of the support portion 2d increases from the left side toward the right side (+X side), when the support portion 2d moves toward the left side, the first portion 3a in contact with the support portion 2d is lifted up, and the lock arm 3 rotates counterclockwise around the rotation shaft 3d when viewed from the rear side (−Y side). Thus, the meshing part 3c approaches the lock gear G, and meshes between the teeth Ga as shown in FIG. 1. Thus, the lock gear G enters the locked state LS.

On the other hand, when the driven shaft 2a and the connection portion 2b rotate counterclockwise, when viewed from the lower side, from the state shown in FIG. 1, the rod 2c and the support portion 2d move toward the right side (+X side). When the support portion 2d moves toward the right side, the first portion 3a lifted up by the support portion 2d moves toward the lower side by its own weight or by receiving a force from the lock gear G, and the lock arm 3 rotates clockwise around the rotation shaft 3d when viewed from the rear side (−Y side). Thus, the meshing part 3c is separated from the lock gear G, and is disengaged from between the teeth Ga as shown in FIG. 2. Thus, the lock gear G enters the unlocked state ULS.

In the present embodiment, as shown in FIG. 1, when the rotation angle θ of the output shaft 61 of the electric actuator 10 is 0°, the lock gear G is in the locked state LS. On the other hand, as shown in FIG. 2, when the rotation angle θ of the output shaft 61 of the electric actuator 10 is the angle θe, the lock gear G is in the unlocked state ULS. Therefore, by changing the rotation angle θ of the output shaft 61 from 0° to the angle θe, the lock gear G switches from the locked state LS to the unlocked state ULS, and when the rotation angle θ of the output shaft 61 changes from the angle θe to 0°, the lock gear G switches from the unlocked state ULS to the locked state LS.

When switching the lock gear G from the locked state LS to the unlocked state ULS, the required output of the electric actuator 10 is large as compared with switching the lock gear G from the unlocked state ULS to the locked state LS. The reason is explained below. In the locked state LS, the lock arm 3 meshes with the lock gear G to stop the rotation of the lock gear G connected to the axle. Therefore, a large load is applied to the lock arm 3, and the first portion 3a is strongly pressed against the support portion 2d. Therefore, when switching the lock gear G from the locked state LS to the unlocked state ULS, a relatively large force is required to move the support portion 2d toward the right side (+X side). Therefore, when switching the lock gear G from the locked state LS to the unlocked state ULS, the required output of the electric actuator 10 is relatively large.

On the other hand, in the unlocked state ULS, since the lock arm 3 does not mesh with the lock gear G, no load is applied to the lock arm 3 from the lock gear G. Thus, the first portion 3a is not strongly pressed against the support portion 2d, and the support portion 2d is easily moved in the left-right direction X. Therefore, when switching the lock gear G from the unlocked state ULS to the locked state LS, the required output of the electric actuator 10 is relatively small.

According to the present embodiment, the ratio between the first distance L1, which is from the meshing position EP to the central axis J1 of the motor shaft 41, and the second distance L2, which is from the meshing position EP to the output central axis J3 of the output shaft 61, when viewed along the axial direction Z, changes in at least a portion of the range from 0°, which is the first rotation angle, to the angle θe, which is the second rotation angle. Therefore, at least the rotation angle θ, at which the ratio of the second distance L2 to the first distance L1 is relatively large and the output of the electric actuator 10 is relatively large, and the rotation angle θ, at which the ratio of the second distance L2 to the first distance L1 is relatively small and the output of the electric actuator 10 is relatively small, are included in the range of the rotation angle θ from 0° to the angle θe. Thus, by determining the rotation angle θ of the electric actuator 10 at the time of rotating the drive target according to the output of the electric actuator 10 required for rotating the drive target, suitable output is able to be added to the drive target.

Specifically, the rotation angle θ of the output shaft 61 when the output required to rotate the drive target is relatively large is set to the rotation angle θ at which the output of the electric actuator 10 is relatively large. Further, the rotation angle θ of the output shaft 61 when the output required to rotate the drive target is relatively small is set to the rotation angle θ at which the output of the electric actuator 10 is relatively small. Thus, the drive target is able to be driven suitably without increasing the output of the electric actuator 10 as a whole. Therefore, the electric actuator 10 is able to be miniaturized.

In addition, for example, when the output of the electric actuator 10 is constant regardless of the rotation angle θ, at the rotation angle θ where the output required to rotate the drive target is relatively small, an unnecessarily large output is applied to the drive target. Therefore, the total output of the electric actuator 10 tends to be large with respect to the total amount of work when the drive target is driven, and the energy efficiency of the electric actuator 10 tends to be low. In contrast thereto, according to the present embodiment, the rotation angle θ is determined according to the output required, by which the rotation angle θ of the output shaft 61 when the output required to rotate the drive target is relatively small is able to be set to the rotation angle θ at which the output of the electric actuator 10 is relatively small. Therefore, the drive target is prevented from being driven with an unnecessarily large output. Thus, the energy efficiency of the electric actuator 10 is able to be improved.

Furthermore, when the output of the electric actuator 10 is relatively small, the deceleration ratio, which is the ratio of the rotation speed of the output gear 53 to the rotation speed of the drive gear 62, is relatively small. Therefore, at the rotation angle θ where the required output of the electric actuator 10 is relatively small, the rotation speeds of the drive gear 62 and the output shaft 61 are able to be increased. Thus, the responsiveness of the electric actuator 10 is able to be improved.

In the present embodiment, the drive target of the electric actuator 10 is the movable part 2 of the actuator device 1. As described above, the output required to drive the movable part 2 becomes relatively large when the lock gear G is switched from the locked state LS to the unlocked state ULS. In contrast thereto, in the present embodiment, the lock gear G is in the locked state LS at the rotation angle θ(θ=0°) where the output of the electric actuator 10 is the largest. Therefore, the output of the electric actuator 10 is able to be set relatively large in the initial stage of switching the lock gear G from the locked state LS to the unlocked state ULS. Thus, the support portion 2d in a state where a relatively large load is applied from the lock arm 3 is able to be moved toward the right side easily.

The output of the electric actuator 10 decreases as the rotation angle θ approaches the angle θe from 0°. However, if it is possible to start moving the support portion 2d in the locked state LS, the lock arm 3 starts to move in the direction away from the lock gear G, and the load applied to the support portion 2d is greatly reduced. Therefore, the output of the electric actuator 10 required to move the support portion 2d is also reduced significantly. That is, when switching the lock gear G from the locked state LS to the unlocked state ULS, a large output is required in the initial stage of starting to move the movable part 2, but the required output decreases after the movable part 2 has moved to some extent. Thus, even if the output of the electric actuator 10 decreases as the rotation angle θ approaches the angle θe, the movable part 2 is able to be moved appropriately. Moreover, since the rotation speed of the output shaft 61 increases as the output of the electric actuator 10 decreases, the moving speed of the movable part 2 also increases. Thus, the moving speed of the movable part 2 is able to be increased after the output required to move the movable part 2 becomes relatively small. Therefore, the responsiveness when switching the state of the lock gear G with the electric actuator 10 is able to be improved.

Further, according to the present embodiment, the drive gear 62 extends toward the output gear 53 and has the second meshing part 62a at the tip end. Therefore, the size of the drive gear 62 is able to be reduced as compared with the case where the drive gear 62 is an elliptical gear like the output gear 53, for example. Thus, the size of the housing 11 that accommodates the drive gear 62 is able to be reduced. Therefore, the electric actuator 10 is miniaturized more easily.

In addition, according to the present embodiment, the ratio between the first distance L1 and the second distance L2 continuously changes from 0°, which is the first rotation angle, to the angle θe, which is the second rotation angle. Therefore, as compared with the case where a portion with the ratio between the first distance L1 and the second distance L2 unchanged is provided, for example, the first meshing part 53a and the second meshing part 62a are easily defined into relatively simple shapes, such as a shape along an ellipse as in the present embodiment.

Furthermore, according to the present embodiment, the ratio of the second distance L2 to the first distance L1 decreases from 0°, which is the first rotation angle, toward the angle θe, which is the second rotation angle. Therefore, by switching the lock gear G from the locked state LS to the unlocked state ULS when changing the rotation angle θ from 0° to the angle θe, the movable part 2 is able to be easily moved with a relatively large output in the initial stage of switching, and the moving speed of the movable part 2 is able to be gradually increased to improve the responsiveness. Thus, the configuration in which the ratio of the second distance L2 to the first distance L1 decreases from 0° toward the angle θe is particularly useful when applied to the electric actuator 10 of the actuator device 1 for switching the lock gear G.

Further, according to the present embodiment, the first meshing part 53a has a shape along a portion of the ellipse centered on the central axis J1, and the second meshing part 62a has a shape along a portion of the ellipse IE centered on the output central axis J3. Therefore, the ratio between the first distance L1 and the second distance L2 is able to be changed while the first meshing part 53a and the second meshing part 62a have relatively simple shapes.

In addition, according to the present embodiment, the arc portion 62b of the outer edge of the drive gear 62, which sandwiches the output central axis J3 with the second meshing part 62a, has an arc or substantially arc shape centered on the output central axis J3. Therefore, even if the rotation angle θ of the output shaft 61 changes, the portion on the right side of the drive gear 62 does not protrude toward the radial outer side of the output central axis J3. Thus, the size of the housing 11 that accommodates the drive gear 62 is able to be reduced, and the electric actuator 10 is able to be miniaturized more easily. In the present embodiment, the first connection wall 38c of the tubular wall 38 is arranged along the arc portion 62b, so that the size of the tubular wall 38 is able to be reduced, and the housing 11 as a whole is able to be miniaturized easily.

Further, according to the present embodiment, the housing 11 includes the first wall 38a located on one side of the drive gear 62 in the circumferential direction centered on the output central axis J3, and the second wall 38b located on the other side of the drive gear 62 in the circumferential direction centered on the output central axis J3. Therefore, the range in which the drive gear 62 rotates is able to be limited by the first wall 38a and the second wall 38b, and the output shaft 61 is able to be prevented from rotating beyond the required angle. Further, the size of the tubular wall 38 surrounding the drive gear 62 is able to be reduced as compared with the case where the wall facing the drive gear 62 in the circumferential direction of the output central axis J3 is not provided. Therefore, the housing 11 and the electric actuator 10 are able to be miniaturized more easily.

In addition, according to the present embodiment, the angle φ defined by the first wall 38a and the second wall 38b when viewed along the axial direction Z is 90° or less. Therefore, the size of the tubular wall 38 is able to be reduced as compared with the case where the angle φ is an obtuse angle. Therefore, the housing 11 and the electric actuator 10 are able to be miniaturized more easily.

Furthermore, according to the configuration of the deceleration mechanism 50 of the present embodiment described above, the rotation of the output shaft 61 is able to be decelerated relatively greatly with respect to the rotation of the motor shaft 41. Therefore, the rotational torque of the output shaft 61 is able to be relatively increased. Thus, it is easy to secure the output of the electric actuator 10 while the electric actuator 10 is miniaturized.

Nevertheless, the disclosure is not limited to the above-described embodiments, and other configurations may be adopted within the scope of the technical idea of the disclosure. The ratio between the first distance L1 and the second distance L2 may change in any manner as long as the ratio changes in at least a portion of the range from the first rotation angle to the second rotation angle. The ratio between the first distance L1 and the second distance L2 may be constant in a portion of the range from the first rotation angle to the second rotation angle. The ratio of the second distance L2 to the first distance L1 may be repeatedly increased and decreased from the first rotation angle to the second rotation angle.

The shape of the first meshing part and the shape of the second meshing part are not particularly limited. The shape of the first meshing part and the shape of the second meshing part may be appropriately determined according to how the ratio between the first distance L1 and the second distance L2 changes. The shape of the first meshing part and the shape of the second meshing part may be a shape along a polygonal shape. In the above-described embodiment, the output gear 53 is provided with the gear portion on only a portion of the outer circumference, but the disclosure is not limited thereto. The gear portion may be provided on the entire circumference of the output gear. In the above-described embodiment, the output gear 53 may have a shape that is cut out except for the portion provided with the first meshing part 53a, which is the gear portion, similarly to the drive gear 62.

The structure of the deceleration mechanism is not particularly limited. The protrusions of the deceleration mechanism may be defined on the external gear, and the holes of the deceleration mechanism may be defined on the output gear. In that case, the protrusions protrude from the external gear toward the output gear and are inserted into the holes.

The application of the electric actuator to which the disclosure is applied is not particularly limited. The electric actuator may be mounted on a shift-by-wire type actuator device that is driven based on a shift operation of the driver. Further, the electric actuator may be mounted on a device other than a vehicle. The configurations described in this specification are able to be combined appropriately within a range where no contradiction arises.

Features of the above-described preferred embodiments and the modifications thereof may be combined appropriately as long as no conflict arises. While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An electric actuator, comprising:
a motor part comprising a motor shaft extending in an axial direction;
a deceleration mechanism connected to one axial side of the motor shaft;
an output part comprising an output shaft to which rotation of the motor shaft is transmitted via the deceleration mechanism; and
a housing accommodating the motor part, the deceleration mechanism, and the output part,
wherein the output shaft extends in the axial direction of the motor shaft and is arranged away from the motor shaft when viewed along the axial direction,
the deceleration mechanism comprises an output gear to which rotation of the motor shaft is decelerated and transmitted,
the output part comprises a drive gear which is fixed to the output shaft and meshes with the output gear,
the output gear comprises a first meshing part which meshes with the drive gear,
the drive gear extends toward the output gear and comprises a second meshing part which meshes with the first meshing part at a tip end,
the first meshing part and the second meshing part mesh with each other within a range from a first rotation angle to a second rotation angle of a rotation angle of the output shaft, and
a ratio between a first distance from a meshing position where the first meshing part meshes with the second meshing part to a central axis of the motor shaft, and a second distance from the meshing position to a central axis of the output shaft, when viewed along the axial direction, changes in at least a portion of the range from the first rotation angle to the second rotation angle.

2. The electric actuator according to claim 1, wherein the ratio between the first distance and the second distance continuously changes from the first rotation angle toward the second rotation angle.

3. The electric actuator according to claim 2, wherein the ratio of the second distance to the first distance decreases from the first rotation angle toward the second rotation angle.

4. The electric actuator according to claim 1, wherein the first meshing part has a shape along a portion of an ellipse centered on the central axis of the motor shaft, and
the second meshing part has a shape along a portion of an ellipse centered on the central axis of the output shaft.

5. The electric actuator according to claim 1, wherein a portion of an outer edge of the drive gear, which sandwiches the central axis of the output shaft with the second meshing part, has an arc shape centered on the central axis of the output shaft.

6. The electric actuator according to claim 1, wherein the housing comprises:
a first wall located on one side of the drive gear in a circumferential direction centered on the central axis of the output shaft; and
a second wall located on the other side of the drive gear in the circumferential direction centered on the central axis of the output shaft.

7. The electric actuator according to claim 6, wherein an angle defined by the first wall and the second wall when viewed along the axial direction is 90° or less.

8. The electric actuator according to claim 1, wherein the motor shaft comprises an eccentric shaft centered on an eccentric axis that is eccentric with respect to the central axis, and
the deceleration mechanism comprises:
an external gear connected to the eccentric shaft via a bearing and arranged to overlap the output gear when viewed along the axial direction;
an internal gear fixed to surround a radial outer side of the external gear and meshing with the external gear; and
a plurality of protrusions protruding in the axial direction from one of the output gear and the external gear toward the other of the output gear and the external gear, and arranged along the circumferential direction,
wherein the other of the output gear and the external gear comprises a plurality of holes arranged along the circumferential direction,
the hole has an inner diameter larger than an outer diameter of the protrusion, and
the protrusions are respectively inserted into the holes and support the external gear to be swingable around the central axis via inner surfaces of the holes.
